(19) United States
(12) Patent Application Publication
(10) Pub. No.: US 2025/0019078 A1
(43) Pub. Date: Jan. 16, 2025

(54) APPARATUS AND METHOD FOR PAYLOAD DELIVERY

(71) Applicant: Defense Applications Group, LLC, Fletcher, NC (US)

(72) Inventors: Judson Hollifield, Fletcher, NC (US); William Challancin, Fletcher, NC (US); DAN FRANCO, Fletcher, NC (US); Andrew Alderfer, Fletcher, NC (US); Don Atchinson, Fletcher, NC (US); Charles Boyer, Fletcher, NC (US); Aaron Dresback, Fletcher, NC (US)

(73) Assignee: Defense Applications Group, LLC, Fletcher, NC (US)

(21) Appl. No.: 18/714,005

(22) PCT Filed: Oct. 6, 2022
(86) PCT No.: PCT/US22/45928

§ 371 Date: May 28, 2024

Related U.S. Application Data
(60) Provisional application No. 63/252,860, filed on Oct. 6, 2021.

(51) Int. Cl. B64D 17/34; B64D 1/08; F42B 10/06; F42B 10/56

(52) U.S. Cl. CPC B64D 17/34; B64D 1/08; F42B 10/06; F42B 10/56

(57) ABSTRACT

Embodiments of the invention provide a carrier for the organization and delivery of payload when used in conjunction with a motorized vehicle. The carrier comprises a housing defining an interior; at least one holder, wherein the interior of the housing is structured to receive and secure the at least one holder within the interior of the housing; and a delivery system, wherein the delivery system is coupled to the housing and is configured to be deployed and guide the carrier to a predetermined location.

### FIELD OF THE INVENTION

Embodiments of the present invention disclosed herein relate to a carrier for payloads, wherein said carrier is configured for use primarily in motor vehicle applications. Specifically, embodiments of the present invention relate to rapid response and deployment of life-saving payloads from motorized vehicles at high altitudes, low altitudes, and the like, to locations where traditional methods of deployment are not ideal.

### BACKGROUND

During a time of crisis, persons such as military personnel, healthcare workers, and civilians alike may require access to life-saving payloads at a moment's notice. Rapid response to these persons may be required, yet the urgency, location, and conditions of the crisis may prevent traditional cargo-carrying motorized vehicles from safely reaching their desired target drop-off locations.

Traditional methods of supplying payloads to such persons typically involve maneuvering large cargo-carrying motorized vehicles to a location in the vicinity of a crisis, which may unnecessarily put more lives at risk and in danger. These methods are also time-consuming and require extraordinary levels of planning and coordination, all of which further add to the time required to carry out such missions.

Accordingly, there is a need for an apparatus which can leverage the strengths of motor vehicle speeds and being able to be deployed from these motor vehicles to specific locations with minimal risk to personnel. There is a need for rapid payload reloading of such an apparatus in conjunction with the motorized vehicle, in order to carry out successive payload delivery missions in an organized fashion while minimizing the downtime in between missions in order to deliver a high volume of payload within a short amount of time.

### BRIEF SUMMARY

Embodiments of the carrier apparatus are described below. In accordance with some embodiments the carrier for delivering a payload, the carrier comprises a housing. The housing defines an interior therein, and the interior is structured for receiving one or more holders. The carrier further comprises a delivery system which is coupled with the housing and configured to be deployed and guide the carrier to a predetermined location.

In some embodiments or in combination with the previous embodiment, the housing defines a body section, which has a first end and a second end. The housing also defines a nose cone, which is located adjacent to the first end and is configured to absorb kinetic energy. The housing also defines a tailpiece which is located adjacent to the second end.

In some embodiments or in combination with any of the previous embodiments, the delivery system defines a parachute and controller.

In some embodiments or in combination with any of the previous embodiments, the carrier further defines one or more cargo access doors located adjacent to the housing, configured to allow for the insertion, removal, and viewing of the holders.

In some embodiments or in combination with any of the previous embodiments, the carrier further defines a mounting system which is located adjacent to the housing and is configured to accept a weapon station of a motorized vehicle.

In some embodiments or in combination with any of the previous embodiments, the housing further defines a rear cover which is rotatably connected to the housing and is configured to expose the delivery system.

In some embodiments or in combination with any of the previous embodiments, the housing further defines a plurality of aerodynamic fins.

In some embodiments or in combination with any of the previous embodiments, the carrier further defines one or more cargo access doors located adjacent to the housing and rotatably connected to the housing, configured to allow for the insertion, removal, and viewing of the holders.

In some embodiments or in combination with any of the previous embodiments, the holders further defines one or more apertures configured to receive and secure a payload.

Some embodiments of the invention are directed to a method for transporting payload within a carrier, alone or in combination with any of the previous embodiments. The method typically comprises one or more steps of: placing one or more payload into a holder, securing one or more holders to an interior within a housing of a carrier, attaching the carrier to a weapon station of a motorized vehicle, releasing the carrier while the motorized vehicle is at an altitude, opening a rear cover, opening a delivery system comprising a parachute and a controller, and landing the carrier on the nose cone.

In some embodiments or in combination with the previous embodiment, the method step of landing the carrier on the nose cone further defines reducing the length of the nose cone as a result of ground impact force in the longitudinal direction.

In some embodiments or in combination with any of the previous embodiments, the method step of opening the tail piece further defines opening a rear cover rotatably connected to the housing, where the rear cover is configured to expose the delivery system.

In some embodiments or in combination with any of the previous embodiments, the method step of securing one or more holders further defines securing one or more cargo doors to the housing.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

The present embodiments are further described in the detailed description which follows in reference to the noted drawings by way of non-limiting examples of the present embodiments on which like reference numerals represent parts throughout the several views of the drawings.

The foregoing and other features of the invention, and the manner in which the same are accomplished, will become more readily apparent upon consideration of the following detail description of the invention taken in conjunction with the accompanying drawings, which illustrate non-limiting examples of embodiments of the present invention and which are not necessarily drawn to scale in the drawings:

FIG. 1 depicts a perspective view of an embodiment of a carrier, in accordance with the embodiments described herein;

FIG. 2 depicts a cutaway perspective view of an embodiment of a carrier, in accordance with the embodiments described herein;

FIG. 3 depicts a perspective view of the rear section of an embodiment of a carrier, in accordance with the embodiments described herein; and

FIG. 4 depicts a perspective view of an embodiment of an array of holders, in accordance with the embodiments described herein.

### DETAILED DESCRIPTION OF EMBODIMENTS OF THE INVENTION

The following detailed description refers to the accompanying drawings, which illustrate specific embodiments. Other embodiments having different structures and operation do not depart from the scope of the present disclosure.

Certain terminology is used herein for convenience only and is not to be taken as a limitation on the embodiments described. For example, words such as “top”, “bottom”, “upper,” “lower,” “left,” “right,” “horizontal,” “vertical,” “upward,” and “downward” merely describe the configuration shown in the figures. Indeed, the referenced components may be oriented in any direction and the terminology, therefore, should be understood as encompassing such variations unless specified otherwise. Throughout this disclosure, where a process or method is shown or described, the method may be performed in any order or simultaneously, unless it is clear from the context that the method depends on certain actions being performed first. Typically, like reference numerals refer to the same or similar parts.

The present disclosure describes embodiments of a carrier for organization and delivery of payloads. In addition, the present disclosure describes various components of the carrier, including but not limits to: a nose cone, main body, tail piece, mounting system, aerodynamic fins, cargo access doors, holders, rear cover, parachutes, controller, etc.

In some embodiments of the invention, payloads are delivered using carriers in conjunction with motor vehicles. Motor vehicles are typically the last physical touchpoint for a carrier before the carrier is released to the location where a payload is needed. Motor vehicles may comprise airplanes, drones, helicopters, gliders, boats, submarines, ATVs, cars, trucks, and tanks, as well as other forms of motorized transportation which may be required in order to transport a carrier from one place to another.

Some embodiments of the invention are such that the invention may be wholly or partly re-used for subsequent payload deliver missions after a particular mission is complete. This re-use cycle may comprise refurbishment steps that aim to replace particular components either (i) after each use, and/or (ii) at regular maintenance intervals following repeated usage of the apparatus. In some embodiments of the invention, re-use may not be feasible, as collecting the apparatus after use may be a prohibitively challenging task. As such, the apparatus may be designed as a one-time use device. In other embodiments of the invention, re-use may be a significantly easier task, but refurbishment may not be feasible. In such cases, the invention may be designed to be extremely robust and not require any maintenance prior to re-use.

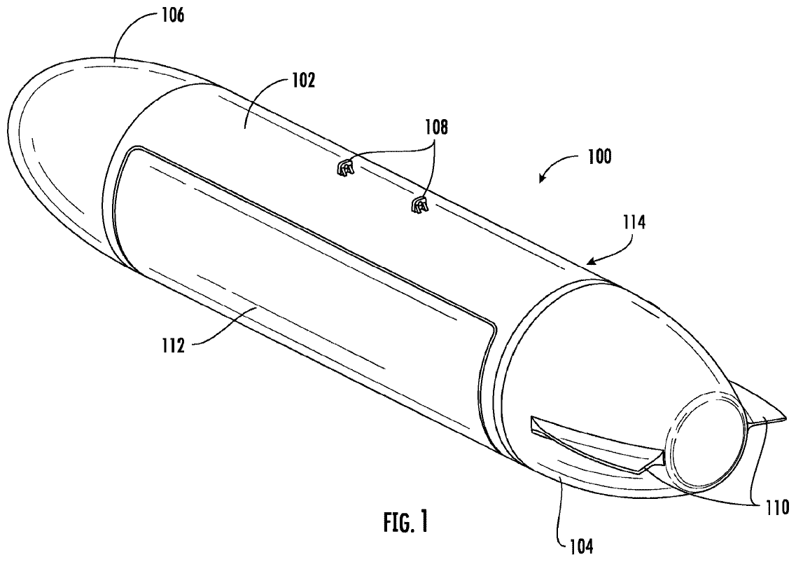

FIGS. 1, 2, and 3 depict perspective views of one embodiment of the carrier 100 of the present invention. Carrier 100 comprises a housing 114 defining an interior, at least one holder 202 releasably secured within the interior of the housing, and a delivery system coupled to the housing and configured to be deployed and guide the carrier to a predetermined location.

The housing 114 comprises a body section 102, tail piece 104, and nose cone 106. In some embodiments of the invention, body section 102 has a first end and a second end, wherein the first end and the second end are positioned on opposite sides of body section 102 from one another. In some embodiments, the first end and the second end of the body section 102 may have circular outer diameter cross-sections and the cross-section profile may maintain the same outer diameter along the entire longitudinal axis of body section 102 or the outer diameter may taper from the middle of the body section toward either the first or second end of the body section or both. In some embodiments, the length of the longitudinal axis of the body section is equal to or longer than the outer diameter of the cross section. In some embodiments, the body section 102 has a cross section which is a polygon. In some embodiments, the cross section of body section 102 has complex curvature. In some embodiments, the cross-section profile along the longitudinal axis changes dimensions. For example, the cross section of body section 102 may have a first end and a second end which both have circular cross sections of diameter “X”, but the circular cross section of the area in the midpoint between the first end and the second end along the longitudinal axis may have a larger diameter “2X” or a smaller diameter “0.5X”.

Housing 114 defines an interior wherein payload may be stored. The geometry of this interior is generally rectangular cuboid in nature, however in some embodiments of this invention, spherical, cylindrical, cuboid or other three-dimensional geometric interiors may be used.

In the depicted embodiment of FIG. 1, body section 102 is coupled with at least one cargo access door 112 such that cargo access door 112 serves to access the interior within housing 114. In some embodiments, there may be a plurality of cargo access doors 112. The at least one cargo access door 112 may be rotatably hinged or removable, or both. Once cargo access door 112 is removed or moved out of the way by rotating about the corresponding hinge or hinges, the interior within housing 114 is visible and exposed such as to accept loading or unloading of objects within the housing 114. In some embodiments of the invention, cargo access door 112 is completely removeable, such that cargo access door 112 may be detached and stowed in another location while payloads are being placed within the interior of housing 114. In such an instance, cargo access door 112 may be returned to its previous location along body section 102 and subsequently secured into place using mechanical locking or securing devices such as latches, mechanical fasteners, bolts, rivets, magnets, and the like, or simply by geometric interference fitment. In some embodiments, cargo access door 112 may be rotatably connected to body section 102, such that cargo access door 112 pivots along one or more sets of hinges or hinge-like mechanisms and secured into place within the corresponding aperture of the body section 102 using one or more mechanical locking or securing devices, as discussed above. In some embodiments, the cargo access door 112 may be assisted with opening and closing using mechanisms comprising gas cylinders, springs, pneumatic actuators, servomotors, electric actuators, rotary dampers, or combinations thereof.

Body section 102, tailpiece 104, nose cone 106, and cargo access door 112 may be fabricated out of similar, the same, or dissimilar materials from one another, depending on the use-case. In some embodiments, materials may be chosen from a list comprising ferrous alloys (e.g., carbon steel, low-alloy steel, tool steel, stainless steel, cast iron, etc.), aluminum, aluminum alloys, nickel alloys, copper alloys, titanium, titanium alloys, polymers (e.g., thermoplastic polymers, thermosetting polymers, elastomers, foams, etc.), ceramics (e.g., glass, cements, clay products, refractories, abrasives, etc.) and composites (e.g., particulate composites, fibrous composites, laminated composites, etc., including, for example, carbon fibers).

A nose cone 106 is positioned at the first end of body section 102. The nose cone 106 can be formed integrally with or attached to the first end of body section 102. Generally, nose cone 106 is conical in geometry, with the larger flat end of the conical shape being located adjacent to body section 102. The end of nose cone 106 opposite of the larger flat end is typically rounded in such a way as to avoid a sharp point. In some embodiments, the end of nose cone 106 opposite of the larger flat end is a sharp point, as is ideal for particular use-cases (such as penetrating dense foliage), and so it is fabricated as such. In another embodiment, the end of nose cone 106 opposite of the larger flat end may be designed to be flat with a circular cross section.

Nose cone 106 is generally the first component of carrier 100 to touch down during an airborne delivery process. Touch down can include touch down on terrafirma or in a body of water. As such, nose cone 106 may experience a significant amount of impact forces and stresses as a result of the deceleration process between in-air velocity and zero velocity once carrier 100 touches down and the kinetic energy of the carrier at the time of touch down. In some embodiments of the invention, nose cone 106 is designed to withstand these impact forces without any notable material deformation. However, in other embodiments, nose cone 106 is specifically designed to deform under the impact forces so as to absorb the impact forces to thereby prevent or minimize the transmission of the impact forces to the payload secured within the interior of housing 114. The deformation, which can be either permanent or temporary (i.e., recoverable), absorbs and displaces kinetic energy, which prevents or minimizes damage to the cargo payload and the remainder of carrier 100. Prior to reuse of carrier 100, nose cone 106 may be repaired or replaced with a new nose cone 106. In yet another embodiment of the invention nose cone 106 is designed to temporarily deform under the impact forces so as to prevent or minimize the transmission of the impact forces to the payload held within the interior of housing 114. The temporary deformation absorbs and displaces kinetic energy, which prevents or minimizes damage to the payload and the remainder of carrier 100. Prior to reuse of carrier 100, nose cone 106 may naturally return to the original shape of nose cone 106 naturally, as is in the case with flexible materials such as foam, rubber, etc., or naturally or with the addition of heat as is the case with certain shape-memory alloys, such as nickel titanium alloys.

In some embodiments, nose cone 106 may be mechanically attached to body section 102 using fasteners. In other embodiments, nose cone 106 may be attached to body section 102 using adhesives, welding, or other types of permanent bonding.

A tail piece 104 is positioned at the second end of body section 102. The tail piece 104 can be formed integrally with or attached to the second end of body section 102. In some embodiments, tail piece 104 is conical in geometry with a first flat end and a second flat end, wherein the first flat end has as larger cross section along the longitudinal axis when compared to the second end. The first flat end and the second flat end are located opposite to one another. The first flat end of tail piece 104 is posited at the second end of the body section 102.

In some embodiments, tailpiece 104 may be mechanically attached to body section 102 using fasteners. In other embodiments, tailpiece 104 may be attached to body section 102 using adhesives, welding, or other types of permanent bonding.

A plurality of aerodynamic fins 110 may be coupled to tail piece 104 along the curved exterior surface of tail piece 104. In some embodiments, aerodynamic fins 110 are spaced at equal intervals along the exterior circumference of tail piece 104. Aerodynamic fins 110 may be configured to assist in stabilizing the motorized vehicle transporting carrier 100, or configured to assist in stabilizing the descent of carrier 100 after release from the motorized vehicle, or both.

The external portion of body section 102 may comprise one or more mounts 108 that can be used to releasably couple the carrier to a motorized vehicle. In some embodiments, mounts 108 may comprise two lugs which are configured to accept a weapons station (otherwise known as a hardpoint, station, or BRU) of a motorized vehicle typically configured to carry weapons. Mounts 108 may be configured to allow for the uninterrupted release of carrier 100 from a motorized vehicle, wherein the release is triggered by an operator of the motorized vehicle.

In some embodiments, mounts 108 may be approximately centered along the longitudinal axis of the body section 102. In other embodiments, mounts 108 may be biased towards nose cone 106 or tail piece 104, thereby being off-center along the longitudinal axis of body section 102.

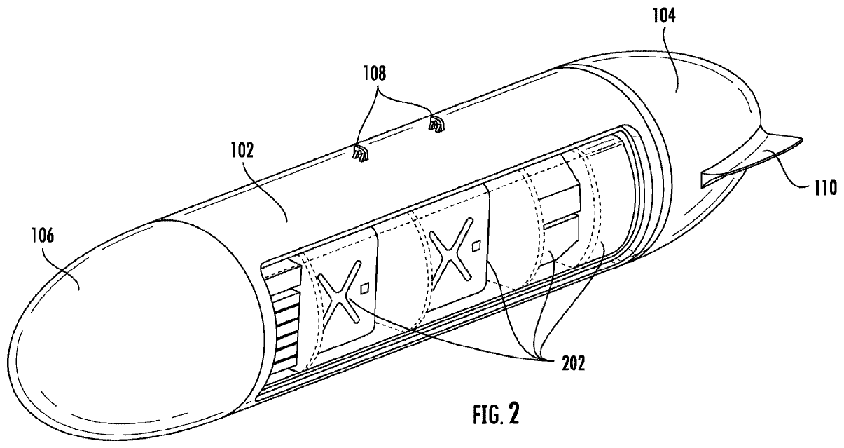

In the depicted embodiment in FIG. 2, carrier 100 is depicted with cargo access door 112 removed. As such, the interior of housing 114 is now visible and is depicted as being filled with a plurality of holders 202. In some embodiments, only one holder 202 may be present, as the geometry of the singular holder 202 may be large enough to fill the entire interior of housing 114. In other embodiments, a plurality of holders 202 may be present. In other embodiments, one or more holders 202 containing payload may be combined with one or more holders without payload, e.g., blanks, whose intended purpose is to fill unnecessary empty space. This may be due to weigh restrictions, weight balance optimization, payload shortage, or the like.

In some embodiments, holders 202 may be configured and structured such that the outer geometry of holders 202 is roughly the same as the corresponding internal void of body section 102. In other embodiments, holders 202 may be configured and structured with reduced geometry to allow for holders 202 to be detachably secured within the interior of the body section 102 using mechanical fasteners, latches, ropes, and the like.

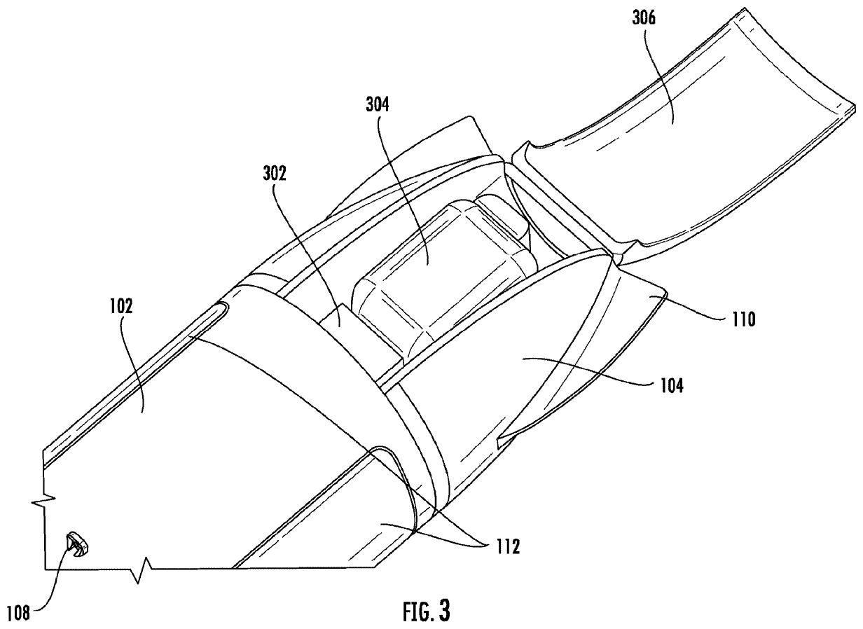

In the depicted embodiment in FIG. 3, housing 114 is further defined as comprising a rear cover 306. In some embodiments, rear cover 308 is rotatably connected to tail piece 104 such that rear cover 306 may rotate a distance along one or more hinges or hinge-like mechanisms to expose the interior of housing 114. In some embodiments, rear cover 306 comprises a latching feature which is operatively coupled with a latching mechanism on body section 102. In some embodiments, rear cover 306 comprises a latching feature which is operatively coupled with a latching mechanism on tailpiece 104. In some embodiments, the latching mechanism is operatively coupled with controller 302.

In one embodiment, the delivery system of the carrier 100 comprises a controller 302 in operable communication with one or more parachutes 304 and configured to release the one or more parachutes 304 into an area external to carrier 100 to reduce the velocity of carrier 100. In some embodiments, the delivery system comprises a single parachute 304 having an approximately hemispherical configuration or an approximately rectangular configuration designed to provide wind resistance and reduce the velocity caused by gravitation forces acting on the falling carrier 100. In other embodiments, the delivery system comprises a plurality of parachutes 304 each having an approximately hemispherical configuration or an approximately rectangular configuration, or a combination of the two. Other known configurations of the parachutes may likewise be used.

In some embodiments, controller 302 may comprise a GPS device to locate the carrier 100 with respect to longitude, latitude, and altitude. In some embodiments, controller 302 may comprise an altimeter configured to deploy or release the parachute or parachutes 304 at a predetermined altitude.

In other embodiments, the delivery system further comprises at least one servomotor in operable communication with the controller 302 to actuate and control the at least one servomotor and guide wires connecting the parachute or parachutes 304 to the at least one servomotor whereby the controller actuates and controls the at least one servomotor in order to control the guidewires of the parachute or parachutes to guide the carrier to a touch down at a predetermined delivery location. In one embodiment, the controller comprises a non-transitory computer-readable medium that stores computer program code that is executable to actuate and control the at least one servomotor.

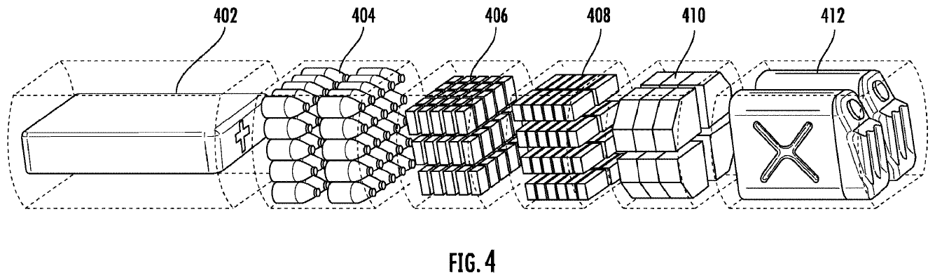

Referring to FIG. 4, an array of holders 202 is shown with several non-limiting examples of payload 402 which may be delivered by carrier 100. Payloads 402 comprise various shapes, length, widths, weights, and heights, as well as various stacking and nesting methods depending on size and number of individual units. Examples of such payloads 402 may include medical supplies, artillery and firearms, ammunition, batteries, fuel sources, solar panels, food, drink, communications devices, spare parts, tools, floatation devices, etc.

Each holders 202 comprises at least one aperture structured or configured to receive and secure a payload. Holders 202 may be configured such that the length of a holder 202 approximates the length of the payload 402 requiring delivery in carrier 100. In some embodiments, a plurality of similar payload 402 are stacked together within a singular holder 202. As such, the length of the holder 202 approximates the length or height of the stack of payload 402.

Managing the weight of the carrier can be important in order facilitate delivery of the carrier 100 to the desired location by the delivery system and to maximize the amount of payload contained in the holders 202. As such, minimizing the weight of the holders 202 is important. This objective can be accomplished in several ways, including configuring the holders 202 such that the dimensions of the holders 202 approximate the dimensions of the specific payload, as discussed above. Additionally, configuring or structuring the holders 202 such that the holders 202 are nestable relative to one another. In one embodiment, each holder 202 comprises at least one aperture structured to receive at least a portion of at least one other holder. For example, the holders 202 may include protuberances and mating apertures such that the aperture of one holder 202 receives a corresponding protuberance or protuberances of another holder 202. This nesting or mating structure is advantageous because it minimizes spacing between the holders 202 when positioned within the carrier or when storing the holders 202 prior to loading with payload or when storing the holders after loading or preloading with payload. Preloading of the holders 202 with payload and storing the preloaded holders 202 can also be advantageous because it minimizes the time required to load the carrier for deployment. For example, in one embodiment, holders can be stackable. In one embodiment, a holder 202 can be configured or structured to receive a specific type of payload and be configured or structured to be nestable, stackable or mate with other holders 202 of the same type only or there may be a common configuration or structure that allows all holders 202 to be nestable, stackable or mate with other holders regardless of the specific payload a holder 202 is configured or structured to receive.

For holders 202 configured or structured to receive a specific type of payload, the holders may be marked with identifying features or designations to easily identify what payload is stored within each holder. This can be advantageous for purposes of loading payload, e.g., allowing the easy identification of the payload being loaded from the holder itself without requiring the person or persons loading the payload into the interior of the carrier to access the payload. This can also be advantageous for the person or persons accessing the carrier after touch down. For example, in an armed-conflict situation or medical emergency, time may be critical to access medical supplies, ammunition, food and water, shelter, etc. or there may be exigent circumstances, such as active military situation which limits the ability of the person or persons accessing the carrier to freely access the interior of the carrier. These identifying features or designations may include shape/configuration, alphanumeric identifications (e.g., “AMMO”, “WATER”, “MEDICAL”, etc.), a color-coding schema either on a portion or all of the exterior of the holders (e.g., holders in solid red or with a portion of the holder marked in red or a red circle, polygon or other identifying mark on the exterior surface or surfaces of the holders for ammunition and other colors for other payload), or a mechanical or electrical device (e.g., a strobe light or infrared emitting device). The identifying features or designations may be visible in both daylight and limited-light situations (e.g., visible at night).

The holders 202 can be constructed of variety of materials. In one embodiment, the holders 202 are constructed of a material having a high strength to weight ratio to minimize weight. For example, the holders 202 can be structured of plastic or other synthetic materials that have a relatively high hardness, stiffness and durability. The holders 202 can also be constructed in whole or in part of metal, such as aluminum, an aluminum alloy, titanium, or a titanium alloy. In some embodiments, materials may be chosen from a list comprising ferrous alloys (e.g., carbon steel, low-alloy steel, tool steel, stainless steel, cast iron, etc.), aluminum, aluminum alloys, nickel alloys, copper alloys, titanium, titanium alloys, polymers (e.g., thermoplastic polymers, thermosetting polymers, elastomers, foams, etc.), ceramics (e.g., glass, cements, clay products, refractories, abrasives, etc.) and composites (e.g., particulate composites, fibrous composites, laminated composites, etc., including, for example, carbon fibers).

In some embodiments, one or more racks configured and structured to store preloaded holders prior to loading into a carrier or the housing may include racks configured to receive and store the holders within the interior of the body section. In other embodiments, the interior of the body section can be configured or structured to receive the holders. For example, the interior of the body section may include one or more slots, each configured and structured to receive a holder. The slots can have fixed or adjustable width. For example, the slots may be formed using partitions that extend the entire height of the interior of the body section or extend only partially from the surface of the body section into the interior. The partitions may be fixed or slidable along the length of the interior of the body section allowing for holders having different widths. The partitions may include fixed or adjustable protuberances that are matingly received within apertures of the holders to secure the holders within the slots once the partitions are positioned on each side of the holder.

In some embodiments, holders 202 may comprise a flexible material such that the payload 402 being held in the holders 202 are secured by material under stress or pressure when payloads 402 are placed within apertures of holder 202. In some embodiments, the flexible material of a holder may be prestressed or biased to secure the payload. In some embodiments, holders 202 may have clamshell features, wherein one or more portions of the holders 202 open to allow for loading and securing of payloads 402. In some embodiments, holders 202 are configured such that the internal geometry of holders 202 forms one or more apertures for receiving and securing payload 402. The outer surfaces of the holders 202 can be structured to approximately follow the geometry of the interior of housing 114.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention may be described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention may be described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

Although specific terms are employed herein, they are used in a generic and descriptive sense only and not for purposes of limitation. Accordingly, it is intended that the present invention not be limited to the described embodiments, but that it has the full scope defined by the language of the following claims, and equivalents thereof. In addition, where possible, any terms expressed in the singular form herein are meant to also include the plural form and/or vice versa. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Furthermore, references to “one embodiment” of the present invention are not intended to be interpreted as excluding the existence of additional embodiments that also incorporate the recited features. The following claims are in no way intended to limit the scope of the disclosure to the specific embodiments described herein. While the foregoing is directed to embodiments of an apparatus and method for delivering a payload and components thereof, other and further embodiments may be devised without departing from the basic scope thereof, and the scope thereof is determined by the claims that follow.

What is claimed is:

1. A carrier for delivering a payload, the carrier comprising:
a housing defining an interior;
at least one holder releasably secured within the interior of the housing; and
a delivery system, wherein the delivery system is coupled to the housing and is configured to be deployed and guide the carrier to a predetermined location.

2. The carrier according to claim 1, wherein the housing comprises:
a body section having a first end and a second end;
a nose cone, wherein the nose cone is positioned at the first end of the body section and is structured to absorb kinetic energy; and
a tail piece, wherein the tail piece is positioned at the second end of the body section.

3. The carrier according to claim 1, wherein the delivery system comprises:
a parachute; and
a controller, the controller being in operable communication with the parachute to control the orientation of the parachute and the decent of the carrier.

4. The carrier according to claim 3, wherein the delivery system further comprises:
at least one servomotor in operable communication with the controller to actuate and control the at least one servomotor; and
guide wires connecting the parachute to the at least one servomotor.

5. The carrier according to claim 4, wherein the controller comprises a non-transitory computer-readable medium that stores computer program code that is executable to actuate and control the at least one servomotor.

6. The carrier according to claim 1, wherein the housing comprises at least one cargo access door configured to allow for the insertion, removal, and viewing of the holders.

7. The carrier according to claim 6, wherein the at least one cargo access door is at least one selected from the group of (i) rotatably hinged and (ii) removable.

8. The carrier of claim 1, wherein the housing comprises a mount structured to releasably secure the carrier to a motorized vehicle.

9. The carrier of claim 1, wherein the tail piece of the housing comprises an access port.

10. The carrier of claim 9, wherein the delivery system deploys through the access port.

11. The carrier of claim 1, wherein the tail piece of the housing further comprises a plurality of aerodynamic fins.

12. The carrier of claim 1, wherein the at least one holder comprises at least one aperture structured to receive and secure a payload.

13. The carrier of claim 1, wherein at least two holders are nestable.

14. The carrier of claim 1, wherein at least two holders are stackable.

15. The carrier of claim 1, wherein the at least one holder comprises at least one aperture structured to receive at least a portion of at least one other holder.

16. The carrier of claim 1, wherein the housing comprises at least one aperture structured to receive at least a portion of at least one holder.

17. The carrier of claim 1, wherein the housing comprises at least one slot structured to receive at least one holder.

18. The carrier of claim 1, wherein the housing comprises at least one rack structured to receive at least one holder.

19. The carrier of claim 1, wherein the housing comprises carbon fiber.

20. The carrier of claim 1, wherein the housing comprises a material selected from the group comprising aluminum, an aluminum alloy, titanium, a titanium alloy.

21. A method for transporting payload within a carrier, comprising:
securing at least one payload in a holder;
securing the holder within an interior of a housing of the carrier;
attaching the carrier to a motorized vehicle;
releasing the carrier from the motorized vehicle while the motorized vehicle is at an altitude;
deploying a delivery system; and
guiding the carrier to a predetermined delivery location.

22. A method for transporting payload within a carrier according to claim 21 further comprising preloading a plurality of holders with payload.

23. A carrier for delivering a payload, the carrier comprising: a housing defining an interior; and
a delivery system, wherein the delivery system is coupled to the housing and is configured to be deployed and guide the carrier to a predetermined location.
